(19) United States
(12) Patent Application Publication
(10) Pub. No.: US 2012/0179960 A1
(43) Pub. Date: Jul. 12, 2012

(54) IMAGE LAYOUT ADJUSTMENT APARATUS

(76) Inventors: Ronald S. Cok, Rochester, NY (US); Kathleen A. Mahoney, Spencerport, NY (US)

(21) Appl. No.: 12/986,403

(22) Filed: Jan. 7, 2011

(51) Int. Cl. G06F 17/00

(52) U.S. Cl. 715/243

(57) ABSTRACT

A computer system comprising a computer screen for digitally displaying an image product containing two or more digital images, a processor coupled to the computer screen for implementing a user interface thereon and a mouse for enabling a user to select one of the two or more digital images in the displayed image product, and for enabling the user to selectively digitally increase or decrease a size of the selected one of the digital images with a single user action with respect to at least one other of the digital images.

### CROSS REFERENCE TO RELATED APPLICATION

Reference is made to commonly assigned, co-pending U.S. patent application Ser. No. ______ by Cok et al. (Docket 96744) filed of even date herewith entitled “Image Layout Adjustment Method”, the disclosure of which is incorporated herein by reference in its entirety.

### FIELD OF THE INVENTION

The present invention relates to laying out images with adaptable image templates to provide an improved aesthetic combination for images and templates of diverse sizes and aspect ratios.

### BACKGROUND OF THE INVENTION

Products that include images are a popular keepsake or gift for many people. Such products typically include a picture taken by an individual that is inserted into a product intended to enhance the product, the presentation of the image, or to provide storage for the image. Examples of such products include picture albums, posters, picture calendars, picture mugs, picture ornaments, picture mouse pads, and picture post cards.

Images can also be combined with other images, for example templates including background images and one or more image template openings into which an individual's image can be inserted, either mechanically or electronically with a computer, to form a combined image that displays the individual's image in a pleasing or preferred manner. These image products can be provided in hard-copy form, for example as a printed photo-book, or in electronic form presented by a computer on an electronic display, for example in an on-line album. Imaging products can also include multi-media products, especially when in electronic form, that, for example, can include still images, image groups, image sequences, motion image sequences or audio tracks.

Designing multi-image products can be a daunting challenge for users, particularly when the products include personal images. Software tools that execute on computers can assist users in designing customized multi-image products. Such software products can execute, for example, on home computers. Alternatively, on-line design and printing services accessible through an internet browser interface can assist users in designing and printing a multi-image product. However, further improvements are needed to simplify the design and layout process for complex, multi-image layouts.

For prior-art products using template designs, for example as employed in commercial on-line image product fulfillment and illustrated in prior-art FIG. 7 for a card, users select digital images to be combined with a template 10. The selected digital images are dragged into template openings 12 with a graphic user interface. If one of the selected digital images is too small or has a resolution that is too low for the desired template opening, a warning message is provided. If one of the selected digital images is too large for the template opening, the selected digital image 5 is cropped, for example with a crop box 13 as illustrated in prior-art FIG. 8. Users can change the cropping to suit their own desires. The cropped digital image then becomes the desired digital image for compositing into the template location.

Some templates or image-product pages are free-form, so that the locations and sizes of the user images in the template or on a page are not fixed and can be modified. FIG. 9 illustrates a page 11 on which several template openings 12 are located. The template openings 12 can be located in different locations on the page 11. However, in such a case it is difficult for users to test or visualize the many combinations of images and image layouts possible on a page or in a template. Software tools can provide a “best layout” as determined by heuristics embodied in an image-layout algorithm. Alternatively, a variety of different layouts can be tested. However, in either case it is difficult for users to design a preferred layout for a specific set of user images.

There is a need therefore, for an improved method for laying out user images within an image product.

### SUMMARY OF THE INVENTION

In accordance with a preferred embodiment of the present invention, there is provided a computer system comprising a computer screen for digitally displaying an image product containing two or more digital images, a processor coupled to the computer screen for implementing a user interface thereon and a mouse for enabling a user to select one of the two or more digital images in the displayed image product, and for enabling the user to selectively digitally increase or decrease a size of the selected one of the digital images with a single user action with respect to at least one other of the digital images. The processor automatically modifies a size of the at least one other of the digital images displayed on the computer screen within the image product in response to the user increasing or decreasing the size of the selected one of the digital images. Multiple images can be modified in size simultaneously and also with respect to remaining ones of the multiple digital images. Digitally increasing a size of the digital images can be implemented by interpolating pixels in the digital images.

In another preferred embodiment of the present invention, a computer comprises a computer screen for digitally displaying an image product containing two or more digital images, a processor coupled to the computer screen for implementing a user interface, and an input device for enabling a user to select one of the two or more digital images in the displayed image product and for enabling the user to selectively digitally increase or decrease a size of the selected one of the digital images with the single user action of selecting the digital image. The single user action can be a mouse click, contacting a touch screen, or a touch pad actuation. The user interface detects a user selecting one of the two or more digital images in the displayed image product and automatically increases or decreases its size. The present invention provides a simplified and natural system for adapting a multi-image layout on a page.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate preferred embodiments whose elements are not interchangeable. In fact, many of the elements described as related to a particular preferred embodiment can be used together with, and possibly interchanged with, elements of other described preferred embodiments. Many changes and modifications may be made within the scope of the present invention without departing from the spirit thereof, and the invention includes all such modifications. The figures below are intended to be drawn neither to any precise scale with respect to relative size, angular relationship, or relative position nor to any combinational relationship with respect to interchangeability, substitution, or representation of an actual implementation.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1A illustrates a template having three template openings;

FIG. 1B illustrates a blank page on which digital images can be positioned;

FIG. 1C illustrates a template with composited digital images in the template openings;

FIG. 1D illustrates a template with a selected template opening highlighted;

FIG. 1E illustrates a template with an enlarged selected template opening according to a preferred embodiment of the present invention;

FIG. 1F illustrates a template with an enlarged digital image according to a preferred embodiment of the present invention;

FIG. 2A illustrates a template with an enlarged selected template opening and a reduced template opening according to a preferred embodiment of the present invention;

FIG. 2B illustrates a template with an enlarged selected template opening and two reduced template openings according to a preferred embodiment of the present invention;

FIG. 3A illustrates a template with a reduced selected template opening and an enlarged template opening according to a preferred embodiment of the present invention;

FIG. 3B illustrates a template with a reduced selected template opening and two enlarged template openings according to a preferred embodiment of the present invention;

FIG. 4A illustrates a template with two enlarged selected template openings according to a preferred embodiment of the present invention;

FIG. 4B illustrates a template with two enlarged selected template openings and a reduced template opening according to a preferred embodiment of the present invention;

FIG. 5 illustrates an image template having a template opening overlapping another template opening according to a preferred embodiment of the present invention;

FIG. 6 is a flow graph illustrating a method according to a preferred embodiment of the present invention;

FIG. 7 is a prior-art illustration of a greeting card template;

FIG. 8 illustrates a prior-art interface for cropping a digital image;

FIG. 9 is an illustration of a prior-art template with openings;

FIG. 10 illustrates a cropped digital image useful in understanding a preferred embodiment of the present invention;

FIG. 11 is a computer system illustration useful in a preferred embodiment of the present invention;

FIG. 12 is a computer system illustration useful in an preferred embodiment of the present invention; and

FIGS. 13A and 13B are illustrations of a multi-image product layout according to preferred embodiments of the present invention.

### DETAILED DESCRIPTION OF THE INVENTION

According to the present invention, an image product is a product that includes a user's personalized image(s) incorporated into an image-related object, such as for example a photo-book, a picture greeting card, a picture mug, or other image-related product. A multi-image product is an image product that incorporates a plurality of user images. The images can be located in specified pre-determined locations or can be adaptively located according to the sizes, aspect ratios, orientations and other attributes of the images. An image product template is a background image having template openings into which user images are to be placed and then composited with the background template to provide an aesthetically appealing combined image that can be rendered, printed, or otherwise communicated, for example by email. In some preferred embodiments of the present invention, the pre-defined templates are adaptable in size, aspect ratio, orientation, and location to complement diverse digital images, for example digital images having different sizes, resolutions, orientations, or aspect ratios. A free-form template is one in which the location of digital images is not pre-determined and the locations can be chosen to complement the available or selected digital images to be incorporated therein. In one case, a blank page is considered a free-form template. In another case, a free-form template has a background pattern or image elements providing a compositional theme. Templates or multi-image products can include a single page, multiple pages, a photo-book, or a photo-collage.

As used herein, a digital image can include multi-media elements including sound and motion. For example, video sequences, still images, groups of still images, or image sequences all include digital images and can be considered a digital image for the purposes of this invention.

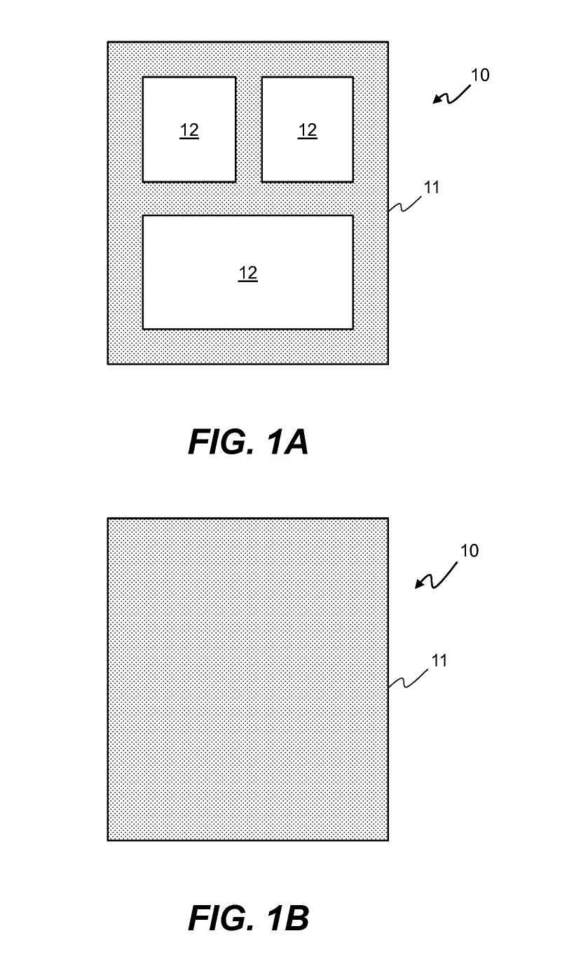

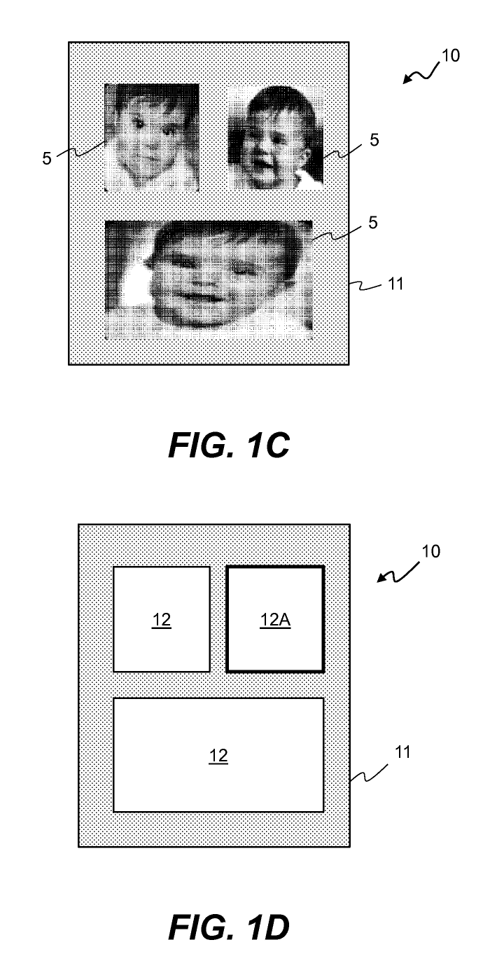

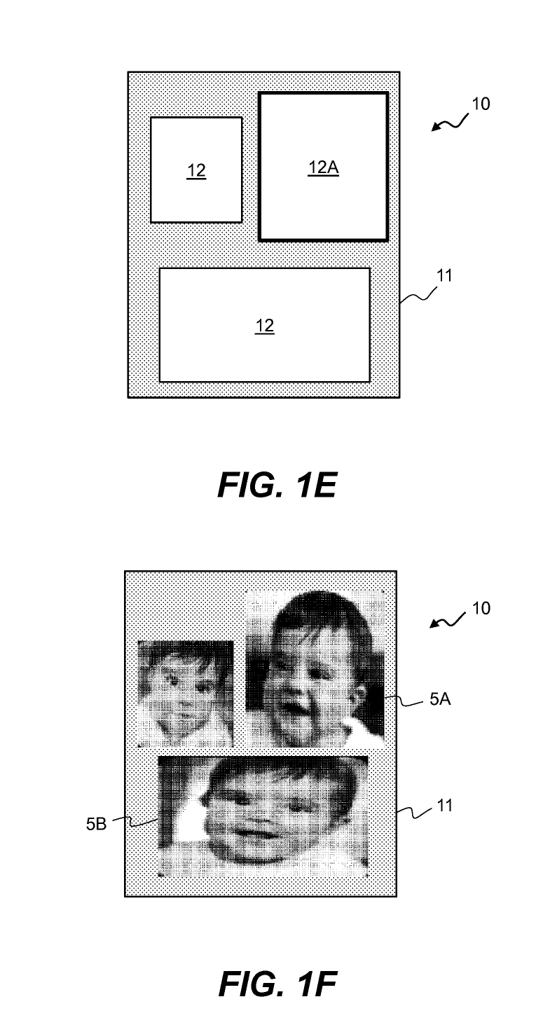

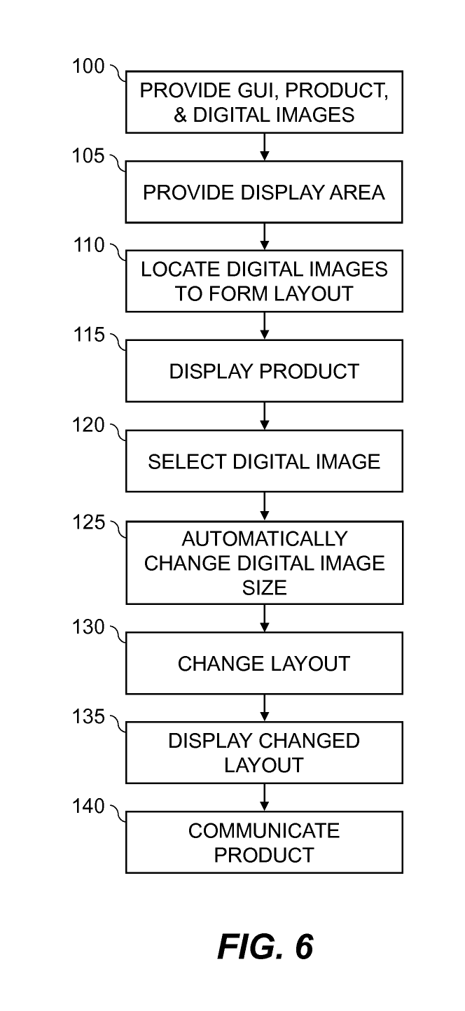

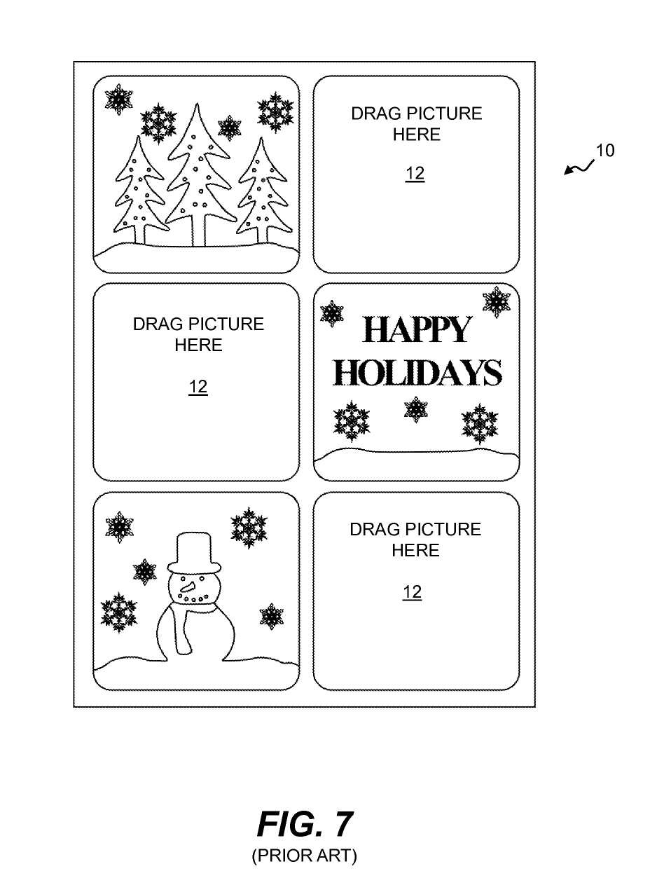

Referring to FIGS. 1A and 6, in an preferred embodiment of the present invention, a method of making an image product comprises the steps of providing a graphic user interface for displaying digital images and digital image templates, a multi-image product template 10 having a layout, for example with template openings 12, and two or more digital images, in step 100. The multi-image product template can be a page 11 with openings 12 for digital images located thereon, as shown in FIG. 1A. Alternatively, the multi-image product template can be a page 11 with or without openings or background thematic elements, as shown in FIG. 1B. In step 105, a display area in the graphic user interface is provided for displaying the multi-image product and the two or more digital images. Graphic user interfaces with display areas, such as windows, are well known in the computer and computer graphics arts, as are circuits and programs for displaying digital images and templates.

Referring to FIG. 1C and step 110 of FIG. 6, at least two digital images 5 are located in different locations in the multi-image product to lay out the at least two digital images in the multi-image product. As shown in FIG. 1C, the digital images 5 are located in the template opening locations illustrated in FIG. 1A. However, in various preferred embodiments, the digital images 5 could also be located in any position on the page 5, as desired by a user, for example by dragging and dropping the images into openings indicated in a template using a graphic user interface or by locating the digital images in arbitrary locations on the page 11. In one preferred embodiment, the digital images 5 are located on the page 11 using a software program with incorporated heuristics to provide an aesthetically pleasing distribution of the digital images on the page 11. The digital images laid out in the multi-media product are displayed in step 115 of FIG. 6.

Referring to FIG. 1D and in step 120, one of the two or more digital images 12A in the laid-out multi-image product in the display area is selected. In FIG. 1D, the selected digital image is indicated with a highlighting dark border. Other highlights, or none at all, can be used. Referring to FIG. 1E and in step 125, the size of the selected digital image 12A is automatically increased or reduced with respect to at least one other digital image in the multi-image product to change the layout of the at least two digital images in the multi-image product. It is to be understood that the automatic size increase or reduction is performed in response to a single user action such as a mouse click on the selected digital image 12A. Contacting a touch sensitive screen is another example of a single user action. Thus, a mouse, tablet, or a touch screen or touch pad actuation device can be used to implement aspects of the present invention. The unselected digital images 12 are also automatically adjusted with respect to size or position within the image product, if necessary to accommodate the size increase or decrease of digital image 12A, substantially simultaneously with its automatic size change. For clarity, the digital images are not shown in FIGS. 1D and 1E and the template openings 12, 12A are shown instead. In the case in which free-form pages are used so that digital images can be located arbitrarily on the page, a digital image is selected to enlarge or reduce it. In the case in which a template with openings is presented to the user, either a template opening or a digital image composited into a template opening can be selected. As intended herein, a reference to selecting a digital image composited into a template opening also includes selecting a template opening even if no digital image is yet composited into the opening.

An enlarged digital template opening is one that takes a relatively greater amount of the area in the multi-image product, template, or page. A reduced digital template opening is one that takes a relatively smaller amount of the area in the multi-image product, template, or page. For example, a template opening that occupies 20% of the area on a page can be enlarged to occupy 30% of the area on a page. Similarly, a template opening that occupies 40% of the area on a page can be reduced to occupy 25% of the area on a page. An opening or digital image cannot occupy more than 100% of the area of a multi-image product. As used herein, changes in the absolute size of an entire printed multi-image product do not constitute enlarging or reducing a digital image, template opening, or multi-image product as applied in the present invention. An enlarged digital image or template opening is one that has been increased in size with respect to the size of the multi-image product and a reduced digital image or template opening is one that has been decreased in size with respect to the size of the multi image-product.

Referring to FIG. 1F, the multi-image product with the changed layout and the enlarged digital image is displayed in the display area, in step 130 and, in step 135 the multi-image product with the changed layout is displayed and communicated in step 140. Communicating the multi-image product can take the form of sending a product file that contains the digital image over a network. In conventional, prior art, image manipulation software tools, images or objects are typically enlarged or reduced by selecting and then dragging corners or sides of a selected image or object. In contrast, according to a preferred embodiment of the present invention, the selection of an image serves to automatically enlarge or reduce the image relative to other images on a page. Preferences as to which change, and its magnitude, is automatically activated can be set and updated as desired by the user. In particular, according to an preferred embodiment of the present invention, when one of the digital images or template openings is selected, thereby automatically increasing or decreasing the size of the image, the remaining template openings or digital images are automatically relocated, resized, or both, within the multi-image product so as to re-layout the images in the multi-image product. The amount of enlargement or reduction in image size is or dependent on preferences specified and stored in the software tool, attributes of the image, the image location, placement of other images, or the layout of the images.

According to other preferred embodiments of the present invention, the process described above can be repeated to iteratively and incrementally increase or decrease the size of a selected digital image. For example, in a graphic user interface employing a two-button mouse, one button might be used to increase the size of the selected image while the second might be used to decrease the size of the selected image, thus enabling a user to try a number of size options and select the preferred one. The amount of size change can be set with user preference selection or arbitrarily determined in software. In various preferred embodiments of the present invention, users could change the size of one digital image and then change the size of a different digital image in the same multi-image product. The process of the present invention readily enables a user to experiment simply and intuitively with different sizes of digital images in a multi-image product. Digital images can be selected in a graphic user interface by locating a graphic pointer over the image and actuating a button, for example with a mouse or track ball.

The present invention provides a simple way for users to emphasize or deemphasize selected images in a layout. It is often the case that particular images in a group of images have special meaning, interest, or emotional value to a user or a gift recipient. By enlarging such an image in a layout, additional attention is brought to the enlarged image and the layout with images is more representative of the user's desires with respect to the multi-image product. Moreover, by enabling a simple mechanism for emphasizing or deemphasizing an image in a layout, the user can readily experiment with different arrangements in a conceptually simple way that can be easily reversed should the experiment be unsuccessful. Prior-art methods of attempting to select a template arrangement before selected images are assigned to selected template locations are not readily compatible with layout experimentation, since an entire layout with all of the selected images must be redesigned for each separate arrangement. Alternatively, prior-art methods of randomly selecting new arrangements can be very tedious and the different arrangements are difficult to compare so as to select the preferred arrangement.

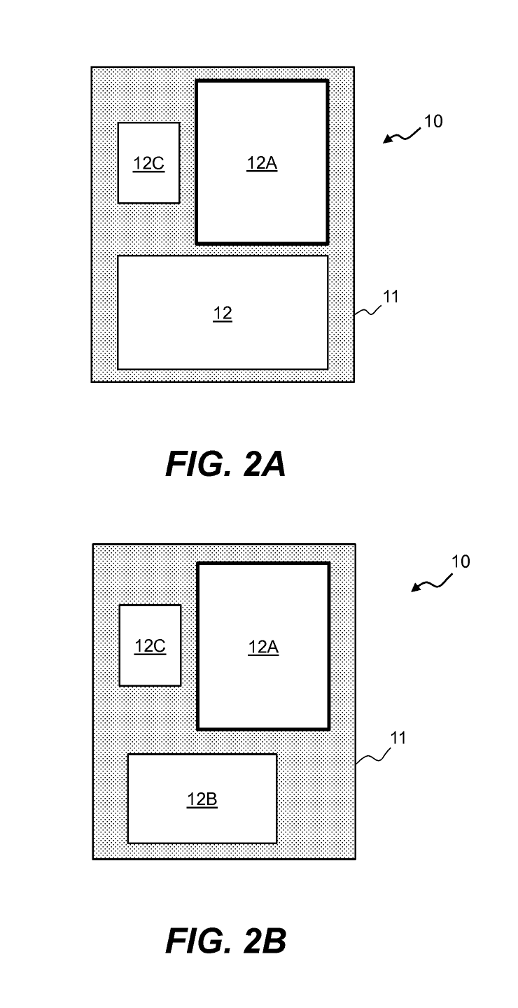

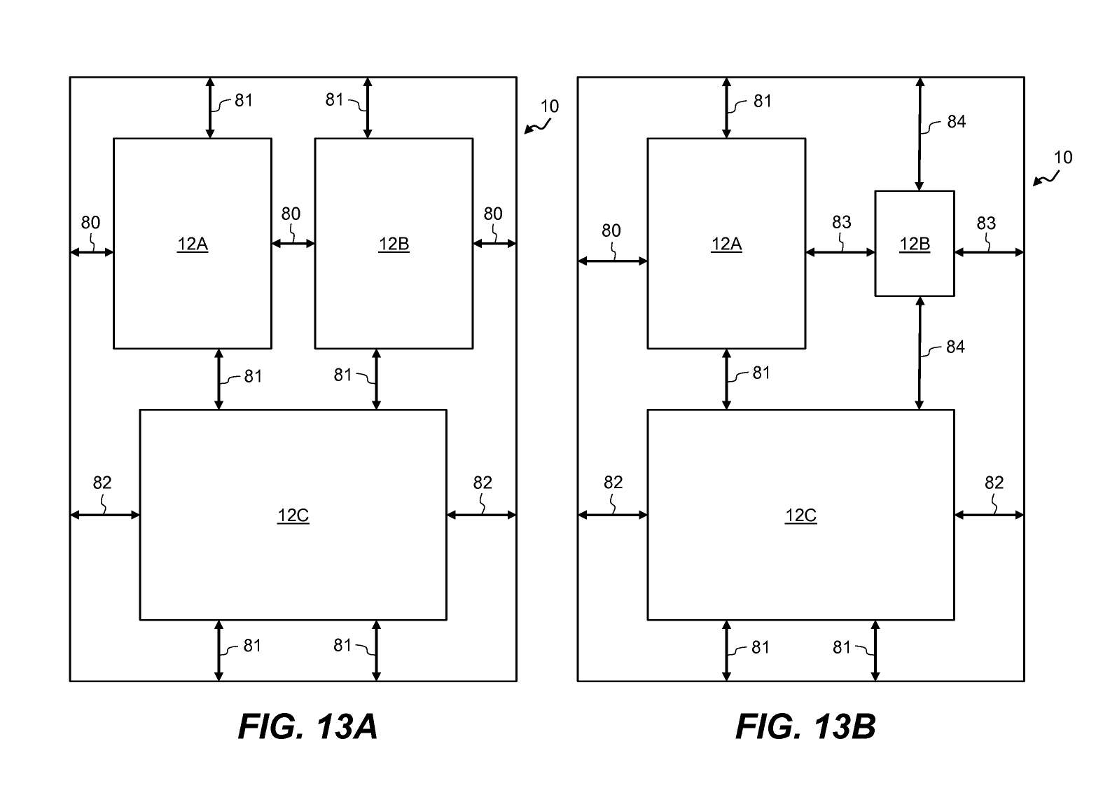

In further preferred embodiments of the present invention, more than one image at a time can be enlarged or reduced. For example, in one preferred embodiment, the size of the selected digital image or template opening is automatically increased and the size of at least one other of the two or more digital images or template openings in the multi-image product is automatically decreased to change the layout of the at least two digital images in the multi-image product. For example, as shown in FIG. 2A, selected template opening 12A is increased in size while opening 12C is decreased in size. Alternatively, the size of all of the others of the two or more digital images in the multi-image product is automatically reduced to change the layout of the at least two digital images in the multi-image product, as illustrated in FIG. 2B where selected template opening 12A is increased in size and template openings 12B and 12C are reduced in size. This is readily accomplished by selecting one image or template opening, for example by clicking a mouse button while a pointer in a GUI is located over the selected image. An enlarged size for the image is then calculated (for example a pre-determined amount, such as a 10% enlargement). Reduced sizes for the remaining images are also computed (for example, such as a 10% reduction). The images are then layed out again on the page, for example by calculating equal-sized gaps between the images in each dimension and between the edges of the multi-image product and the images nearest the edge, and then locating the images with the calculated gaps in each dimension. Alternatively, a different selection mechanism is use to decrease a size of an image. Referring to FIGS. 13A and 13B, in one preferred embodiment of the present invention, equal-sized separations between images and product edges are maintained. As shown in FIG. 13A, images 12A and 12B are separated from the edges of the multi-image product 10 and from each other by equal separation distances 80 in the horizontal direction. Image 12C is separated by the same distance 82 from the multi-image product edges. In the vertical direction images 12A and 12C (and 12B and 12C) are separated from each other and the multi-image product edge by equal separation distances 81. According to a preferred embodiment of the present invention and as illustrated in FIG. 13B, the image 12B is reduced in size by selecting it and the images 12A, 12B and 12C are re-layed out to maintain equal separation distances. The vertical separation distance 81 between images 12A and 12C do not change as those images have not been modified, nor does the horizontal separation distance 82 for digital image 12C. However, the horizontal placement of images 12A and 12B are modified, as is the vertical placement of reduced image 12B. Referring to FIG. 13B the horizontal separation distance 83 between images 12A and 12B and the multi-image product edges is increased as a consequence of the reduction in size of image 12B. Likewise, the vertical spacing between image 12B and image 12C and the top edge of the multi-image product 10 is increased to a separation distance 84.

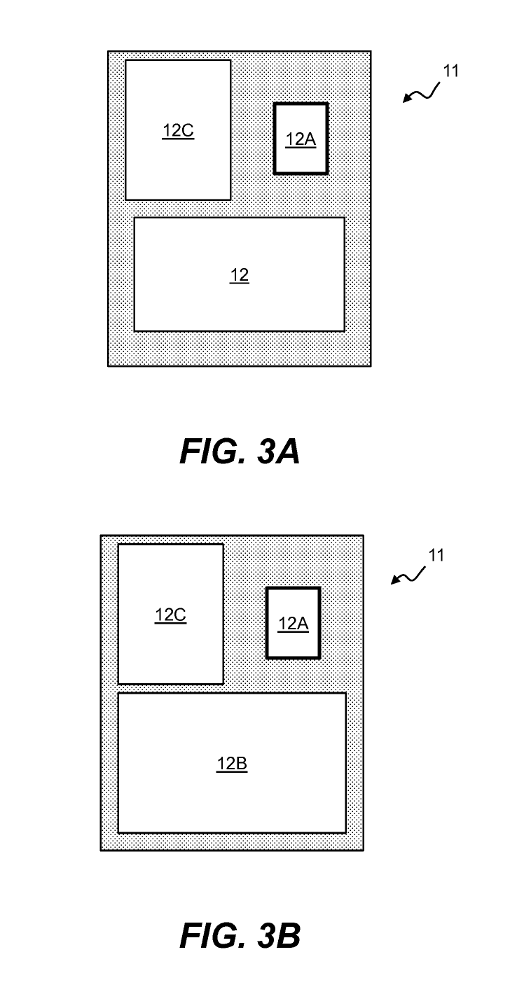

In a corresponding exemplary preferred embodiment, the size of the selected digital image is automatically reduced and the size of at least one other of the two or more digital images in the multi-image product is automatically increased to change the layout of the at least two digital images in the multi-image product as shown in FIG. 3A in which selected template opening 12A is decreased in size and template opening 12C is increased in size. Alternatively, the size of all of the others of the two or more digital images in the multi-image product is automatically increased to change the layout of the at least two digital images in the multi-image product, as shown in FIG. 3B in which selected template opening 12A is decreased in size and template openings 12B and 12C are increased in size.

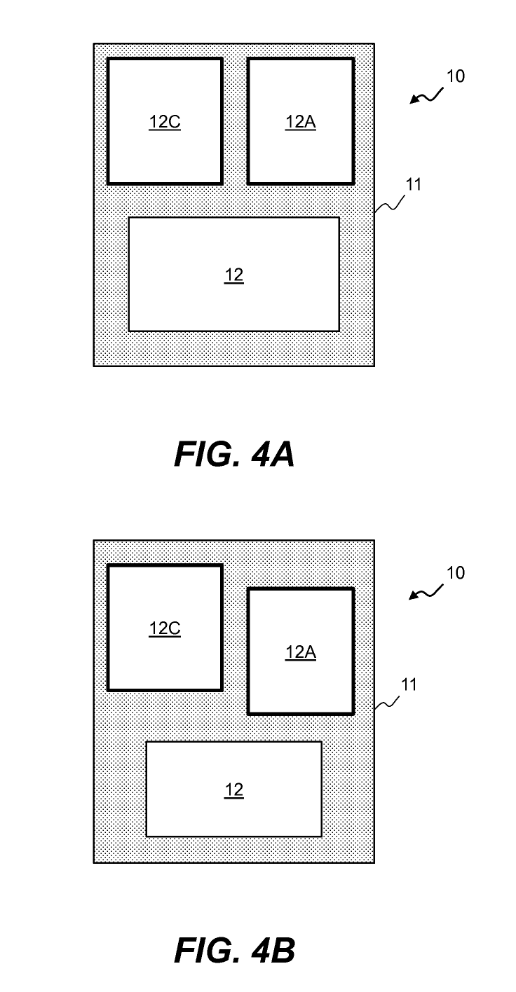

In a different preferred embodiment of the present invention, more than one digital images or template openings can be selected. Referring to FIG. 4A, two of three or more digital images in the laid-out multi-image product in the display area selected and the size of the selected digital images with respect to at least one other digital image in the display area is automatically increased or decreased to change the layout of the at least two digital images in the multi-image product. For example, a user can select a first image and then a second image (for example by locating a pointer over the images and pressing a button, e.g. clicking on the images). Another button can be pressed and the two selected images enlarged or reduced at the same time. Alternatively, one of the selected images (for example the first) can be enlarged while the other selected image (for example the second) is reduced. The use of switches to control the behavior of selected elements in a graphic user interface is well known. For example, clicking a mouse button while holding down the shift or control key on a conventional keyboard is a common practice in graphic user interfaces. In this way, the selection of images whose sizes are changed can be controlled.

Referring to FIG. 4B in another preferred embodiment, one or all of the other digital images or template openings are reduced. As shown in FIG. 4B, the template openings are repositioned to improve the aesthetic effect of the layout.

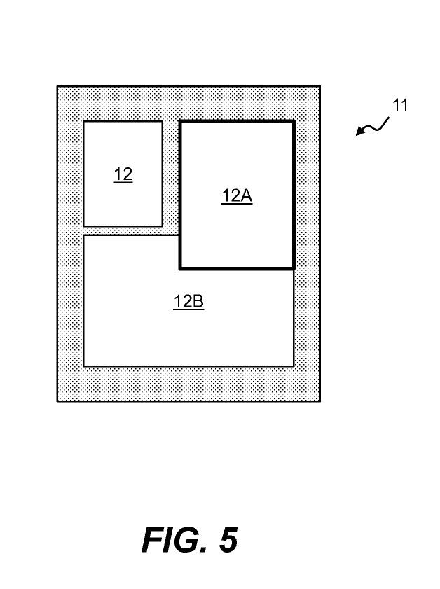

In yet another preferred embodiment of the present invention, referring to FIG. 5, an enlarged selected digital image or template opening can overlap other digital images. Alternatively, other digital images can overlap a selected digital image.

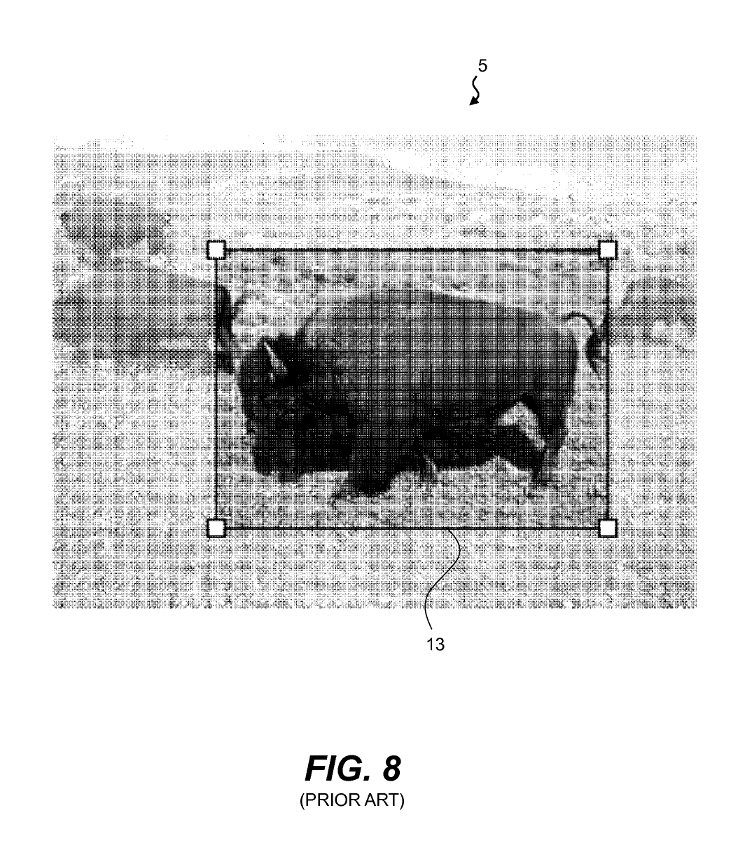

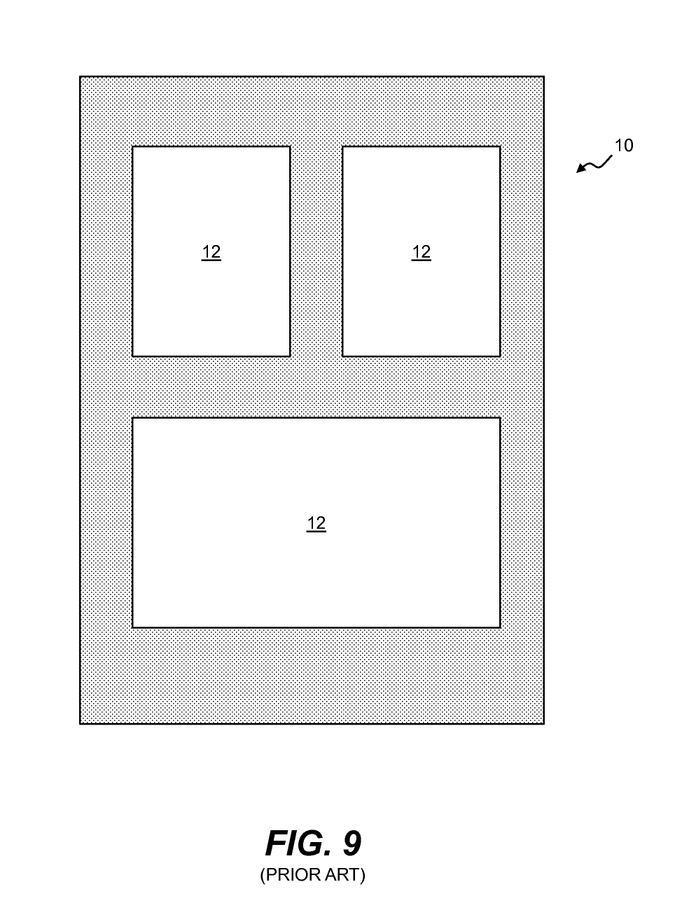

Different digital images employed in the present invention can have different sizes, resolutions orientations, and aspect ratios. It can be convenient, but is not essential, to match the digital images to a corresponding template opening having a similar orientation or aspect ratio. For example, a portrait image can be located in a portrait template opening. Alternatively, a landscape image can be cropped to match the orientation and aspect ratio of a portrait template opening. In general, images can be cropped to match a template opening or simply to improve the aesthetic appearance of the digital image or the digital image within the multi-image product, as illustrated in FIG. 8. Digital images can also be reduced in resolution to reduce the size of the digital image when a number of pixels is limited to reproduce the digital image.

Likewise, templates with pre-defined template openings can include template openings that have different sizes, aspect ratios, and orientations, for example as illustrated in FIG. 1. As noted above, template openings correspond to digital images as used herein. A digital image can be selected and its size increased or decreased. Similarly, a template opening can be selected and its size increased or decreased, or the size of a template opening associated with a digital image, or into which a digital image is composited, can be increased or decreased. As understood herein, these actions are equivalent and are a part of the present invention.

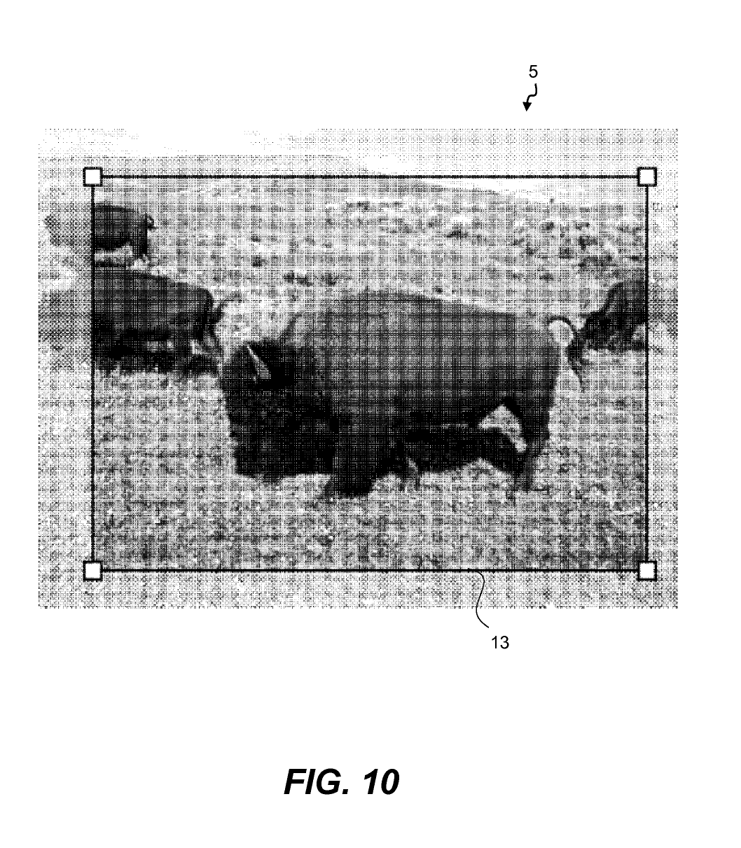

When an image is reduced or cropped and composited into an opening or constrained in size or aspect ratio on a page and then selected for enlargement, the selected digital image can be enlarged in several different ways, according to different preferred embodiments of the present invention. In one preferred embodiment, the cropped image is interpolated to provide more pixels. In another preferred embodiment illustrated in FIG. 10, a larger area and portion of an image than the cropped portion is used, so that the picture includes more pictorial content. In yet another preferred embodiment, a higher resolution version of the digital image is used, thereby improving the quality of the image. Similarly, in another preferred embodiment of the present invention, an image can be reduced by cropping or by averaging pixels in the image to reduce the number of pixels and hence the useful size of the digital image.

Once the digital images are sized and positioned within the multi-image product as desired, the multi-image product and digital images can be communicated for example by rendering into a single image, printing, or emailing the multi-image product. The changed layout of the multi-image product can be stored in a memory for later use or to enable different uses of the multi-image product.

The present invention can be made on a computer executing software that implements a method of the present invention. The software can be a stand-alone application dedicated to a single computer. For example in one preferred embodiment, the graphic user interface is employed by a user to interactively select one or more digital images. Such graphic user interfaces are well known in the computing and computer graphic arts. Alternatively, the present invention can be practiced using a remote server computer connected to a local computer through a communications network, such as the internet. The remote server can provide software and graphic user interface specifications over the network to the local computer, which displays the graphic user interface and executes the software. Such an arrangement is found in commercial image fulfillment systems using web browsers that execute on local computers and web pages and executable code that are served by the remoter server computer to the local computer to accomplish tasks.

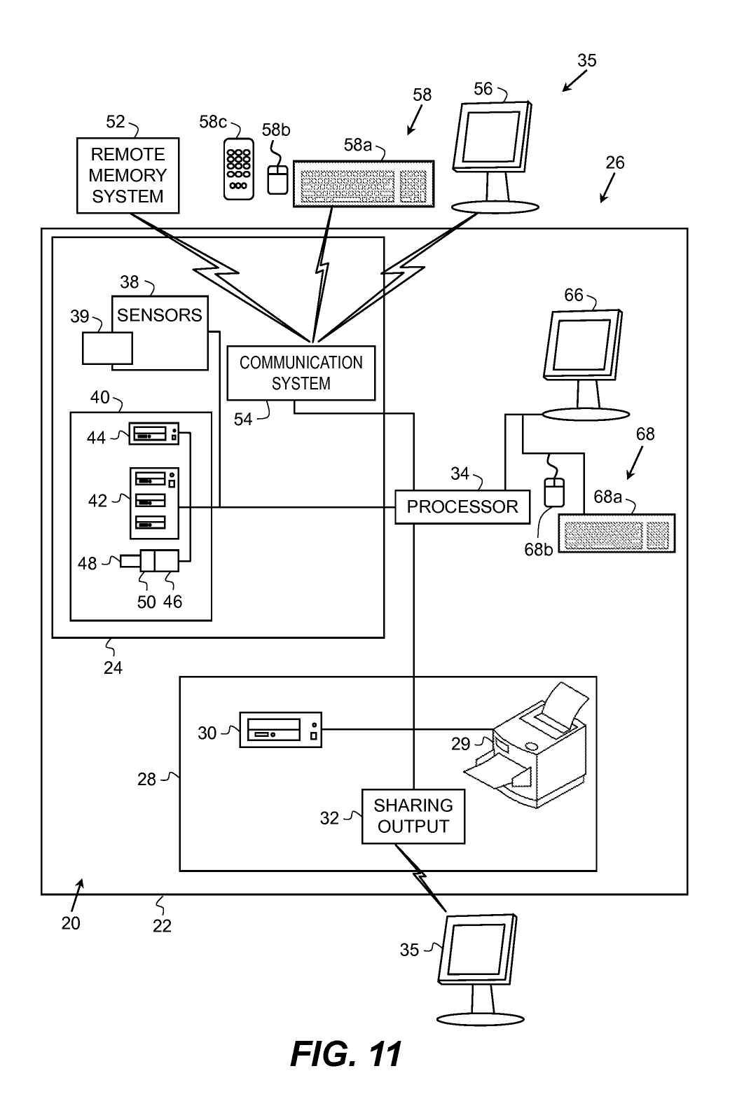

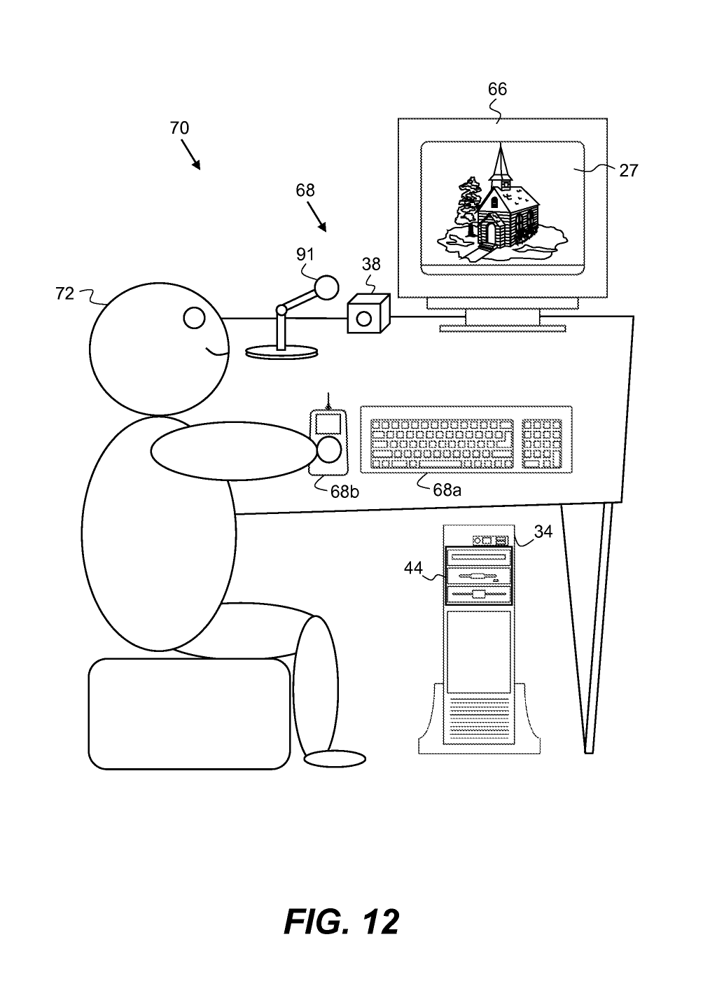

Referring to FIGS. 11 and 12, computers, computer servers, and a communication system are illustrated together with various elements and components that are useful in accordance with various preferred embodiment of the present invention. FIG. 11 illustrates a first preferred embodiment of an electronic system 20 that can be used in generating an image product. In the preferred embodiment of FIG. 11, electronic system 20 comprises a housing 22 and a source of content data files 24, a user input system 26 and an output system 28 connected to a processor 34. The source of content data files 24, user-input system 26 or output system 28 and processor 34 can be located within housing 22 as illustrated. In other preferred embodiments, circuits and systems of the source of content data files 24, user input system 26 or output system 28 can be located in whole or in part outside of housing 22.

The source of content data files 24 can include any form of electronic or other circuit or system that can supply digital data to processor 34 from which processor 34 can derive images for use in forming an image-enhanced item. In this regard, the content data files can comprise, for example and without limitation, still images, image sequences, video graphics, and computer-generated images. Source of content data files 24 can optionally capture images to create content data for use in content data files by use of capture devices located at, or connected to, electronic system 20 and/or can obtain content data files that have been prepared by or using other devices. In the preferred embodiment of FIG. 11, source of content data files 24 includes sensors 38, a memory 40 and a communication system 54.

Sensors 38 are optional and can include light sensors, biometric sensors and other sensors known in the art that can be used to detect conditions in the environment of system 20 and to convert this information into a form that can be used by processor 34 of system 20. Sensors 38 can also include one or more video sensors 39 that are adapted to capture still images or image sequences. Sensors 38 can also include biometric or other sensors for measuring involuntary physical and mental reactions such sensors including, but not limited to, voice inflection, body movement, eye movement, pupil dilation, body temperature, and p4000 wave sensors.

Memory 40 can include conventional memory devices including solid-state, magnetic, optical or other data-storage devices. Memory 40 can be fixed within system 20 or it can be removable. In the preferred embodiment of FIG. 11, system 20 is shown having a hard drive 42, a disk drive 44 for a removable disk such as an optical, magnetic or other disk memory (not shown) and a memory card slot 46 that holds a removable memory 48 such as a removable memory card and has a removable memory interface 50 for communicating with removable memory 48. Data including, but not limited to, control programs, digital images and metadata can also be stored in a remote memory system 52 such as a personal computer, computer network or other digital system. Remote memory system 52 can also include solid-state, magnetic, optical or other data-storage devices.

In the preferred embodiment shown in FIG. 11, system 20 has a communication system 54 that in this preferred embodiment can be used to communicate with an optional remote memory system 52, an optional remote display 56, and/or optional remote input 58. The optional remote memory system 52, optional remote display 56, optional remote input 58A can all be part of a remote system 21 having an input station 58 having remote input controls 58 (also referred to herein as “remote input 58”), can include a remote display 56, and that can communicate with communication system 54 wirelessly as illustrated or can communicate in a wired fashion. In an alternative preferred embodiment, a local input station including either or both of a local display 66 and local input controls 68 (also referred to herein as “local user input 68”) can be connected to communication system 54 using a wired or wireless connection.

Communication system 54 can comprise for example, one or more optical, radio frequency or other transducer circuits or other systems that convert image and other data into a form that can be conveyed to a remote device such as remote memory system 52 or remote display 56 using an optical signal, radio frequency signal or other form of signal. Communication system 54 can also be used to receive a digital image and other data from a host or server computer or network (not shown), a remote memory system 52 or a remote input 58. Communication system 54 provides processor 34 with information and instructions from signals received thereby. Typically, communication system 54 will be adapted to communicate with the remote memory system 52 by way of a communication network such as a conventional telecommunication or data transfer network such as the internet, a cellular, peer-to-peer or other form of mobile telecommunication network, a local communication network such as wired or wireless local area network or any other conventional wired or wireless data transfer system. In one useful preferred embodiment, the system 20 can provide web access services to remotely connected computer systems (e.g. remote systems 35) that access the system 20 through a web browser. Alternatively, remote system 35 can provide web services to system 20 depending on the configurations of the systems.

User input system 26 provides a way for a user of system 20 to provide instructions to processor 34. This allows such a user to make a designation of content data files to be used in generating an image-enhanced output product and to select an output form for the output product. User input system 26 can also be used for a variety of other purposes including, but not limited to, allowing a user to arrange, organize and edit content data files to be incorporated into the image-enhanced output product, to provide information about the user or audience, to provide annotation data such as voice and text data, to identify characters in the content data files, and to perform such other interactions with system 20 as will be described later.

In this regard user input system 26 can comprise any form of transducer or other device capable of receiving an input from a user and converting this input into a form that can be used by processor 34. For example, user input system 26 can comprise a touch screen input, a touch pad input, a 4-way switch, a 6-way switch, an 8-way switch, a stylus system, a trackball system, a joystick system, a voice recognition system, a gesture recognition system a keyboard, a remote control or other such systems. In the preferred embodiment shown in FIG. 11, user input system 26 includes an optional remote input 58 including a remote keyboard 58a, a remote mouse 58b, and a remote control 58c and a local input 68 including a local keyboard 68a and a local mouse 68b.

Remote input 58 can take a variety of forms, including, but not limited to, the remote keyboard 58a, remote mouse 58b or remote control handheld device 58c illustrated in FIG. 11. Similarly, local input 68 can take a variety of forms. In the preferred embodiment of FIG. 11, local display 66 and local user input 68 are shown directly connected to processor 34.

As is illustrated in FIG. 12, local user input 68 can take the form of a home computer, an editing studio, or kiosk 70 (hereafter also referred to as an “editing area 70”) that can also be a remote system 35 or system 20. In this illustration, a user 72 is seated before a console comprising local keyboard 68a and mouse 68b and a local display 66 which is capable, for example, of displaying multimedia content. As is also illustrated in FIG. 12 editing area 70 can also have sensors 38 including, but not limited to, video sensors 39, audio sensors 74 and other sensors such as multispectral sensors that can monitor user 72 during a production session.

Output system 28 is used for rendering images, text or other graphical representations in a manner that allows image-product designs to be combines with user items and converted into an image product. In this regard, output system 28 can comprise any conventional structure or system that is known for printing or recording images, including, but not limited to, printer 29. Printer 29 can record images on a tangible surface using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology, drop-on-demand inkjet technology and continuous inkjet technology. For the purpose of the following discussions, printer 29 will be described as being of a type that generates color images. However, it will be appreciated that this is not necessary and that the claimed methods and apparatuses herein can be practiced with a printer 29 that prints monotone images such as black and white, grayscale, or sepia toned images. As will be readily understood by those skilled in the art, a system 35, 20 with which a user interacts to define a user-personalized image product can be separated from a remote system (e.g. 35, 20) connected to a printer, so that the specification of the image product is remote from its production.

In certain preferred embodiments, the source of content data files 24, user input system 26 and output system 28 can share components.

Processor 34 operates system 20 based upon signals from user input system 26, sensors 38, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit, or a series of discrete components. The system 20 of FIGS. 11 and 12 can be employed to make and display an image product according to a preferred embodiment of the present invention.

The present invention provides advantages over the prior art. Image products incorporating templates composited with digital images provided by users can adapt more readily to a wider variety of user-provided digital images and provide more aesthetic results. Furthermore, multi-image products can be more readily designed, reducing the amount of work on the part of a user and increasing the efficiency of the manufacturing process.

The invention has been described in detail with particular reference to certain preferred embodiments thereof, but it will be understood that variations and modifications can be effected within the spirit and scope of the invention.

### PARTS LIST

5 digital image
5A digital image
5B digital image
10 template
11 page
12 template opening
12A template opening
12B template opening
12C template opening
13 crop box
20 system
22 housing
24 source of content data files
26 user input system
27 graphic user interface
28 output system
29 printer
34 processor
35 remote system
38 sensors
39 video sensor
40 memory
42 hard drive
44 disk drive
46 memory card slot
48 removable memory
50 memory interface
52 remote memory system
54 communication system
56 remote display
58 remote input
58a remote keyboard
58b remote mouse
58c remote control
66 local display
68 local input
68a local keyboard
68b local mouse
70 home computer, editing studio, or kiosk
72 user
74 audio sensors
80 separation distance
81 separation distance
82 separation distance
83 separation distance
84 separation distance
100 provide GUI, product, & digital images step
105 provide display area step
110 locate digital images to form layout step
115 display product step
120 select digital image step
125 automatically change digital image size step
130 change layout step
135 display changed layout step
140 communicate product step

1. A computer system comprising:
a computer screen for digitally displaying an image product containing two or more digital images;
a processor coupled to the computer screen for implementing a user interface thereon and a mouse for enabling a user to select one of the two or more digital images in the displayed image product, and for enabling the user to selectively digitally increase or decrease a size of the selected one of the digital images with a single user action with respect to at least one other of the digital images; and
electronic memory coupled to the processor for storing a digital file containing the modified image product.

2. The system of claim 1, wherein the processor automatically modifies a size of the at least one other of the digital images displayed on the computer screen within the image product in response to the user increasing or decreasing the size of the selected one of the digital images.

3. The system of claim 2, wherein the processor automatically reduces a size of the at least one other of the digital images displayed on the computer screen within the image product in response to the user increasing the size of the selected one of the digital images.

4. The system of claim 2, wherein the processor automatically increases a size of the at least one other of the digital images displayed on the computer screen within the image product in response to the user decreasing a size of the selected one of the digital images.

5. The system of claim 4, wherein the processor automatically increases a size of all others of the digital images displayed on the computer screen within the image product in response to the user decreasing a size of the selected one of the digital images.

6. The system of claim 3, wherein the processor automatically reduces a size of all others of the digital images displayed on the computer screen within the image product in response to the user increasing a size of the selected one of the digital images.

7. The system of claim 1, wherein the processor displays image product contains three or more digital images and wherein the processor automatically increases or decreases the size of the two selected digital images with respect to remaining ones of the three or more digital images.

8. The system of claim 1, wherein the processor renders the modified image product for display on the computer screen.

9. The system of claim 1, further comprising a printer coupled to the processor, wherein the processor sends the digital file to the printer for printing the modified image product.

10. The system of claim 1, further comprising an output port coupled to the processor and coupled to a communication network, wherein the processor emails the modified image product over the communication network.

11. The system of claim 1, wherein the processor digitally increases a size of the selected one of the digital images by interpolating pixels in the selected one of the digital images.

12. The system of claim 1, further comprising storage for storing a plurality of image product templates having two or more different template openings for disposing digital images.

13. The system of claim 1, further comprising storage for storing a plurality of image product templates comprising a multiple page image product, a photo-book, or a photo-collage.

14. A computer comprising:
a computer screen for digitally displaying an image product containing two or more digital images;
a processor coupled to the computer screen for implementing a user interface thereon and an input device for enabling a user to select one of the two or more digital images in the displayed image product, and for enabling the user to selectively digitally increase or decrease a size of the selected one of the digital images with a single user action with respect to at least one other of the digital images, wherein the single user action is selected from the group consisting of a mouse click, touch screen, or touch pad actuation; and
electronic memory coupled to the processor for storing a digital file containing the modified image product.

15. The computer according to claim 14 wherein the user interface detects a user selecting one of the two or more digital images in the displayed image product and automatically increases or decreases a size of said one of the two or more digital images.

16. The computer of claim 15 further comprising electronic storage for storing a user selected step size for defining the step of automatically increasing or decreasing a size of the digital image in the image product.
